(19) United States
(12) Patent Application Publication
(10) Pub. No.: US 2018/0291320 A1
(43) Pub. Date: Oct. 11, 2018

(54) DISTILLING APPARATUS AND METHODS OF USING SAME

(71) Applicant: DAVID BRUCE STONG, COATESVILLE, PA (US)

(72) Inventor: DAVID BRUCE STONG, COATESVILLE, PA (US)

(21) Appl. No.: 15/945,340

(22) Filed: Apr. 4, 2018

Related U.S. Application Data
(60) Provisional application No. 62/482,557, filed on Apr. 6, 2017.

(51) Int. Cl. C12G 3/12; B01D 3/00; B01D 5/00

(52) U.S. Cl. CPC C12G 3/12; B01D 5/006; B01D 3/001

(57) ABSTRACT

A method and apparatus for distilling alcohol or spirits where the distillation occurs, at least in part, in a glass or glass lined vessel. Surface reactions between copper or stainless steel, on one hand, and glass linings, on the other hand, are different. Distillation using glass or glass-lined vessels and condensers avoid the exposure to metals during the distillation and condensation, thus providing for an improved flavor in the resulting spirits.

### CROSS-REFERENCE TO RELATED APPLICATIONS

The present application claims the benefit, under 35 U.S.C. § 119(e), of U.S. Provisional Application Ser. No. 62/482,557 filed Apr. 6, 2017, entitled “Distilling Apparatus,” the entirety of which is incorporated herein by this reference.

### FIELD OF THE DISCLOSURE

This disclosure relates to the use of glass-lined vessels, condensers and their connecting equipment for the purpose of distilling alcoholic (ethanolic) spirits for human consumption. For the purpose of this disclosure, a distilled spirit is an alcoholic beverage produced by distillation of grains, fruit, or vegetables that have gone through alcoholic fermentation. These spirits include, but are not limited to: whiskey, bourbon, rum, gin, vodka, cognac, corn spirits and brandy.

### BACKGROUND

Current methods of distilling spirits involve the use of copper, stainless steel or copper/stainless steel combination stills, either single-pass pot stills or continuously-operating column stills. Stills have been forged from tin, iron, brass and copper since the 15^{th} century, but glass has not been used. The current methods expose the mash, alcoholic vapors and condensed liquids to metal surfaces that can act as catalysts and possess the possibility of leaching metals into the final product, as well as altering the chemistry of the distillate. The catalytic actions and leached metals can alter the chemical composition of the vapors and condensed liquids. These alterations can affect the flavor of the resulting spirits. Indeed, copper is often the preferred material in the construction of a still because it can impart flavor to the distilled spirit, as well as evenly conducting heat for a more even distillation process.

Many classical reactions involving carbon-carbon or carbon-heteroatom bond formation can be catalyzed by Lewis acids such as copper. Examples include the Friedel-Crafts reaction, the aldol reaction (combines two carbonyl compounds (the original experiments used aldehydes) to form a new β-hydroxy carbonyl compound), and various pericyclic processes that proceed slowly at room temperature, such as the Diels-Alder reaction (reaction between a conjugated diene and a substituted alkene) and the ene reaction. In addition to accelerating the reactions, Lewis acid catalysts are able to impose regioselectivity and stereoselectivity in many cases. Ullmann reactions (a coupling reaction between aryl halides and copper), Diels-Alder reactions, ring expansions, Castro-Stevens coupling, and the Kharasch-Sosnovsky reaction.

Compounds such as phenolic compounds (which contribute bitterness and smokiness), esters (fruity flavors and aromas) and other carbonyl compounds, alcohols, nitrogen-containing compounds including pyridines, picolines and pyrazines, sulphur-containing compounds such as dimethyl trisuphide (DMTS, promoting a sulphury aroma) and acetaldehyde are produced in the mash. Acetals are rapidly formed in distillates and a great many are found in distilled beverages, the most prominent being acetaldehyde diethyl acetal (1,1-diethoxyethane). Among whiskies the highest levels are associated with malt whisky. These compounds contribute to the flavor of the final product, and because of the catalytic activity of copper, their distribution may be altered during distillation. Copper also catalyzes the breakdown of esters in the gas phase during distillation. Esters are present during the distillation and add fruity flavors and aromas to the final product, which are desirable. The number and extent of esters and other carbonyl compounds in the fermentation mash and the complex reactions that would be catalyzed by copper are beyond the scope of this discussion. The effect of these compounds on the final flavor is dependent on the concentrations and types of these compounds. However, given the activity of copper as a catalyst, in can be concluded that distillation in copper vessels would alter their distribution in the final product and therefore the final flavor. Substituting glass for the distillation equipment would avoid these alterations, resulting in a different product, which we believe would result in a superior product.

The use of copper for the pot stills for distillation of Scotch malt whisky is regarded as having an important effect on whisky aroma. Sulfur-containing compounds, from the simple hydrogen sulfide to the more complex sulfur-containing aromatic compounds, are the primary cause of off-flavors in whisky. Their presence is reduced by the use of copper stills, as the copper is capable of binding the sulfur compounds, and preventing them from making their way into the final spirit. This is important for Scotch whiskey since the malting process is performed with peat, which could potentially add additional sulphuric compounds to the malt and therefore the mash. While binding of these compounds to the copper in the still reduces the levels of sulphuric compounds in the final product, it requires that the stills be routinely and thoroughly cleaned to remove the bound sulfur compounds

Copper catalyses the breakdown of sulphuric compounds in the gas phase during distillation, which can affect the flavor of the final product. Copper plays the catalyst role in converting thiols and mercaptans to usually less pungent compounds in presence of carbonyls. Methanethiol (CH₃SH) is abundant in nature and in small quantities it contributes to the aromas of nuts and cheeses, but in higher concentrations it smells like rotten vegetables. Mercaptans and thiols are formed to some extent by the yeasts as byproducts from sulfur-containing amino acids, but especially in the event of anaerobic (non-lactic) bacterial infection of the mash. Thus copper improves the quality of the final product when the mash is not fermented purely in the presence of yeast. It would not be as necessary when the fermentation is clean and not infected with bacteria, or under conditions of controlled levels of sulphuric compounds in the mash.

The above discussion has focused on copper, and not stainless steel, because of the greater activity of copper as a catalyst compared to stainless. However, stainless steel is not devoid of catalytic activity and therefore could also alter the composition of the distillate. Further, stainless steel can be corroded over time, especially under acidic conditions, such as those seen in the mash, gas phase and distillate, and can leach metals into the final product. This would not occur using equipment having an inner surface made of glass, allowing better control over the consistency of the final product. And finally, ethyl carbamate can be formed from various substances present in alcoholic beverages and their break-down products as a result of the fermentation process, especially those using cane sugar in the mash. Ethyl carbamate has been shown to be carcinogenic to laboratory animals, and should therefore be avoided in the product. These precursor substances, e.g. urea, cyanate and citrulline, react with ethanol to form ethyl carbamate in alcoholic beverages. It has been suggested that distillation using stainless steel equipment can cause increases in ethyl carbamate in the final product.

These effects are further demonstrated by the observation that copper stills have a limited lifespan. Because of the reactions that occur, the walls of a copper still become thinner with time, giving them a lifespan of between 8 and 25 years. Commercial grade all-copper stills or stainless steel stills with copper domes and stainless steel condensers cost from $30K to $175K for capacities of 100 gallons to 2500 gallons. (Source: Corson Distilling Systems, www.corsondistilling.com). And because the copper binds compounds such as the sulphur-containing compounds, there may be batch-to-batch variations unless the still is thoroughly cleaned between each batch. And even with cleaning between each batch, variations in the cleaning procedure and in the copper surface itself caused by the cleaning may cause variations in the product produced in the first run and any subsequent runs. These problems are avoided by the use of glass-lined vessels and condensers, which do not interact with the mash or its vapors during the distillation process. And glass can be cleaned without altering the surface. Thus, batch-to-batch variations can be more easily avoided, and the lifespan of glass-lined equipment would be almost unlimited.

The distilled spirit business in the United States is lucrative and demand for distilled spirits is increasing. According to the Distilled Spirits Council, in 2016, U.S. sales of distilled spirits rose to $25.2 Billion and, for the seventh year in a row, took market share from beer and wine. Kell, John, 3 Signs the US Liquor Business Had a Great 2016, Fortune, Feb. 7, 2017. The spirits industry now commands 35.9% of the total U.S. alcohol market vs. 47% for beer and 17.1% for wine. Beer made up close to 60% of the alcohol market in the 1990s. Id. As a subset, U.S. whiskey sales increased 7.7% in 2016 to $3.1 Billion. Id. FIG. 1 shows annual sales revenue for U.S. produced spirits for the years 2006-2016 as reported on Feb. 7, 2016 by the Distilled Spirits Council in its 2016 Economic Briefing. Annual sales revenue for the reported decade rose from $17.2 B to $25.2 B, an increase of 47%.

According to the Department of the Treasury Alcohol and Tobacco Trade Bureau Statistical report for distilled spirits, 195,619,818 proof gallons were distilled as whiskey in 2017. That compares to 166,673,701 proof gallons distilled in 2016, an increase of 17%. These figures, as well as those for the previous two years, are an indication of the growth in the industry and the increased demand for distilled spirits overall. In response to that demand, the number of active distiller accounts for craft distillers grew from 609 in 2010 to 2124 in 2016, and their production went from 7,037,248 to 7,356,248 proof gallons over the same period. In addition, information from Pfaudler, Inc., the world's largest manufacturer of glass-lined equipment, says in its brochure (Worldwide Glasteel® 9100) that the company has been manufacturing glass-lined steel process equipment for over 100 years, yet the equipment has yet to be applied to the distillation of spirits for human consumption.

### SUMMARY

According to aspects of the present disclosure, it is proposed that because the surface reactions between copper or stainless steel and glass linings are different, it is believed that the use of glass-lined vessels for distillation will create a different and better flavored end product. Distillation using glass or glass-lined vessels and condensers avoid the exposure to metals during the distillation and condensation, thus providing for an improved flavor in the resulting spirits.

According to aspects of the present disclosure, any glass-lined equipment is used for the distillation of spirits for human consumption, regardless of the thickness of the glass, shapes of the equipment or chemical composition of the glass. Any thickness of the glass or glass lining may be used, since the reactions described above involve surface reactions and do not involve penetration of the mash or vapor into the glass. The thickness may influence the physical characteristics of the distillation, such as heat transfer, but will not affect the reactions at the glass surface. For example, the thickness may be between 0.5 and 4 mm, or preferably between 1 and 2 mm, typically 0.060 inches. The requirement for the thickness is based, not on the thickness required to prevent metal catalysis, but rather on the need for mechanical strength of the glass lining bound to the metal, which is not under the scope of these claims. All shapes and sizes of the still and condenser are also included within the scope of this disclosure, as these parameters may also be optimized to produce the most favorable conditions for the type of spirit being produced—for example, whiskey, bourbon, rum, gin, vodka, cognac, corn spirits, tequila and brandy. For example, the shape may be cylindrical, cylindrical with a domed top, cylindrical with a domed top and bottom, spherical, onion-shaped, cylindrical with a frusto-conical top, cone shaped, inverted frusto-conical with a domed top, cylindrical with a domed top topped with and ogee or domed sphere. Variations in these designs are for the purpose of increasing or decreasing the volume for refluxing prior to directing the vapors to the condenser during distillation (From: “The Craft of Whiskey Distilling, American Distilling Institute, White Mule Press, Hayward Calif. 94543, 2009). The length and diameter of the glass-lined still, pipes and condenser may also be of any size for the same purpose.

Likewise, the claim is for any chemical composition of the glass, as all common glasses do not have the catalytic properties of copper or stainless steel.

Common types of glass, deemed within the scope of the present disclosure, include but are not limited to:

Fused quartz, also called fused-silica glass, vitreous-silica glass: silica (SiO2) in vitreous, or glass, form (i.e., its molecules are disordered and random, without crystalline structure). Silica glass may also include frit mixed with additional ingredients. Frit is a form of silica glass that is a mixture of inorganic chemical substances produced by rapidly quenching a molten, complex combination of materials, confining the chemical substances thus manufactured as nonmigratory components of glassy solid flakes or granules. This category includes all of the chemical substances specified below when they are intentionally manufactured in the production of fit. The primary members of this category are oxides of some or all of the elements listed below. Fluorides of these elements may also be included in combination with these primary substances: Aluminum; Barium; Bismuth; Boron; Calcium; Chromium; Cobalt; Copper; Gold; Iron; Lanthanum; Lead; Lithium; Magnesium; Molybdenum; Nickel; Phosphorus; Potassium; Silicon; Silver; Sodium; Strontium; Tin; Titanium; Vanadium; Zinc.

Sodium borosilicate glass, Pyrex: silica+boron trioxide (B2O3)+soda (Na2O)+alumina (Al2O3Borosilicate glasses (e.g. Pyrex, Duran) have as main constituents silica and boron trioxide.

Aluminosilicate glass: silica+alumina+lime+magnesia+barium oxide (BaO)[11]+boric oxide (B2O3

Given the catalytic and other properties of copper and stainless steel, and the possibility of leaching through corrosion, vessels and condensers having at least an inner surface of glass would provide better control of the mash, gas phase and distillate during the distillation process, resulting in a better and more finely maintained final product.

The Summary is neither intended nor should it be construed as being representative of the full extent and scope of the present invention. Moreover, reference made herein to “the present disclosure” or aspects thereof should not necessarily be construed as limiting all embodiments to a particular description. The present disclosure is set forth in various levels of detail in the Summary as well as in the attached drawing and the Detailed Description and no limitation as to the scope of the present disclosure is intended by either the inclusion or non-inclusion of elements, components, etc. in this Summary.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a graph of annual gross revenue from U.S. sales of distilled spirits for the years 2006 to 2016.

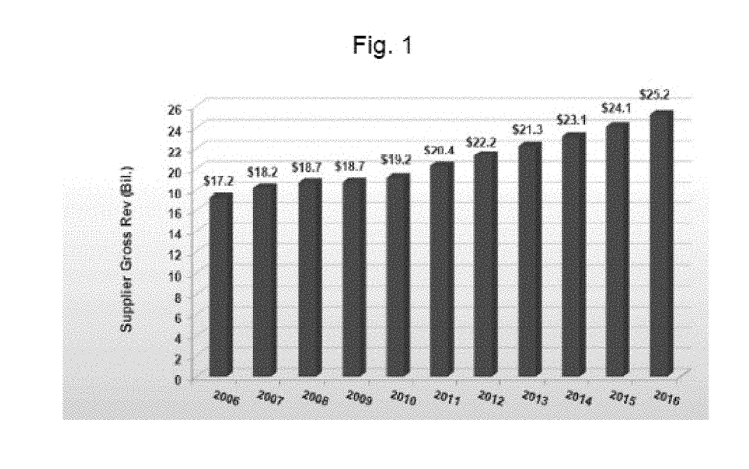

FIG. 2 is a block diagram of a typical distillation process.

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

Current practice involves the use of copper or stainless steel stills, based in part on the belief that these metals remove or avoid unwanted chemicals from the process, especially sulfur-containing compounds. It is believed this is not the case, and that an improved product would result from the use of glass or glass-lined equipment during the distillation and condensation phase of the process.

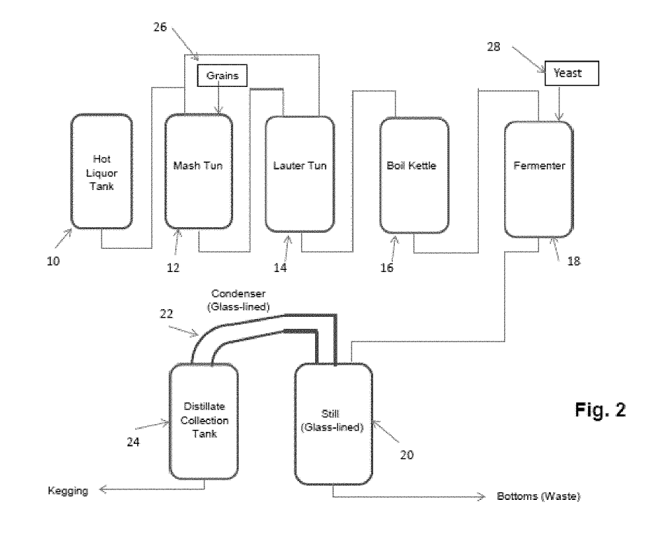

The process and equipment involved in the mashing of grains, fermentation and distillation of spirits is generally represented in FIG. 2. As illustrated, the equipment may include a hot liquor tank 10, a mash tun 12, a lauter tun 14, a boil kettle 16, a fermenter 18, a still 20, a condenser 22 and a distillate collection tank 24. The process starts when hot water (referred to as ‘hot liquor’) is taken from the hot liquor tank 10 and added to crushed grains 26 in the mash tun 12. Temperature and volume are controlled within the mash tun 12 to allow the enzymes in the grain to reduce the polysaccharides in the grain to simple sugars, and proteins to its basic amino acids, which the yeast require as nutrients during fermentation. Once this conversion is complete, the resulting mash may be transferred to the lauter tun 14. In the lauter tun 14 the solubilized sugars and amino acids, referred to as ‘wort’, is separated for the spent grain husks. The wort is transferred to the boil kettle 16. The spent grain husks are rinsed with hot liquor, a process known as ‘sparging’. After boiling the wort and cooling it in the boiling kettle 16, the wort is transferred to a fermenter 18 and yeast 28 is added. The wort is then allowed to ferment for a suitable period. To this point in the process, equipment standard to the industry may be used.

Once fermentation is complete, the fermented wort is transferred to a still 20 and distilled. According to aspects of the present disclosure, the still has an inner surface that is glass. The distillate is cooled to liquid form in a condenser 22 that also has an inner surface made of glass. The cooled condensate is collected in a stainless steel tank 24. The still and condenser may take any shape and configuration desired by those of skill in the art. What is critical is that the inner surface of the still and/or the condenser, as well as any equipment used to connect the still and the condenser, be glass. The glass may be any thickness or chemical composition to be optimized for the type of spirit being distilled. The still and condenser may be glass-lined with an outer shell of copper or other metal.

Once a sufficient volume of distillate is collected in the collection tank 24, the distillate is removed and kegged for aging purposes or bottled for distribution and sale, depending upon the type of spirit being distilled. The waste or bottoms remaining in the still is removed. All of the equipment is cleaned and the process may be repeated. However, the cleaning of the still 20 and condenser 22 is less critical compared to cleaning metal stills and condensers. In the later, sulfur containing compounds bind to the metal surface and remain in the still and condenser after the contents are emptied. Incomplete or inconsistent cleaning of the metal still and condenser leaves such compounds on the inner surfaces and likely results in flavor variations or inconsistencies from batch to batch. Such inconsistencies are difficult to control or eliminate even with standardized cleaning processes. However, a glass surface is not subject to the same variables. No compounds bind to the glass surface. As a result, cleaning the glass surface is easier and the glass surface is consistent from batch to batch, eliminating variability in flavors or taste that is inherent in with metal stills and condensers.

By utilizing a still and condenser with an inner glass surface, the chemical reactions associated with metal stills and condensers is eliminated. The catalytic actions and metal leaching associated with metal stills cannot occur.

By using a glass-lined still/condenser, the levels of specific compounds that can affect the flavor of the spirit may be altered, such as but not limited to mercaptans and thiols hydrogen sulfide (H₂S) and ethanethiol (CH₃SH), esters ethyl hexanoate (C₈H₁₆O₂) and isoamyl acetate (C₇H₁₄O₂), ketones diacetal (C₄H₆O₂) and β-dimascenone (C₁₃H₁₈O), or alcohols phenethyl alcohol (C₈H₁₀O). This is because the still/condenser, at a minimum, has an inner surface made of glass and the distillate is not exposed to or does not come in contact with metal.

While various embodiments of the present disclosure have been described in detail, it is apparent that modifications and alterations of those embodiments will occur to those skilled in the art. However, it is to be expressly understood that such modifications and alterations are within the scope and spirit of the present disclosure, as set forth in the following claims. Other modifications or uses for the concepts and embodiments set forth in the present disclosure will also occur to those of skill in the art after reading the present disclosure. Such modifications or uses are deemed to be within the scope of the present invention.

What is claimed is:

1. A method of making a distilled spirit, comprising:
a. creating a mash;
b. creating a wort from the mash;
c. fermenting the wort; and
d. distilling the fermented wort in a vessel having an inner surface of glass.

2. The method of claim 1, further comprising producing a vapor phase from the distillate and condensing the vapor phase in a condenser having an inner surface of glass.

3. The method of claim 1, wherein in the distilling step the fermented wort does not contact metal.

4. The method of claim 2, wherein in the condensing step the vapor phase produced from the fermented wort does not contact metal.

5. A method of making a distilled spirit, comprising:
a. creating a mash;
b. creating a wort from the mash;
c. fermenting the wort; and
d. distilling the fermented wort in the absence of Lewis acid induced catalytic actions.

6. The method of claim 5, further comprising performing the distillation step in a vessel having an inner surface made of glass.

7. The method of claim 5, further comprising producing a vapor phase from the distillate and condensing the vapor phase in a condenser having an inner surface of glass.

8. The method of claim 6, wherein the distilling step produces a distillate, further comprising producing from the distillate a distilled spirit.

9. The method of claim 8, wherein the distilled spirit comprises at least one of whiskey, bourbon, rum, gin, vodka, cognac, corn spirits and brandy.

10. A vessel used for the distillation of spirits comprising, a container having an inner surface made of glass.

11. The vessel of claim 10, wherein the container comprises an outer surface made of metal.

12. The vessel of claim 10, further comprising a condenser in vapor communication with the container, wherein the condenser has an inner surface made of glass.

13. The vessel of claim 10, wherein the glass comprising the inner surface of the container has a thickness between 0.5 and 4 mm.

14. The vessel of claim 10, wherein the glass comprising the inner surface of the condenser has a thickness between 0.5 and 4 mm.

15. The vessel of claim 10, wherein the glass comprising the inner surface of the condenser comprises at least 100% by volume/mass fused quartz, sodium borosilicate glass or aluminosilicate glass, or 100% of a combination of the three types.

16. The vessel of claim 10, wherein the shape of the container comprises at least one of the following: cylindrical, cylindrical with a domed top, cylindrical with a domed top and bottom, spherical, onion-shaped, cylindrical with a frusto-conical top, cone shaped, inverted frusto-conical with a domed top
